(19) United States
(12) Patent Application Publication
(10) Pub. No.: US 2007/0251596 A1
(43) Pub. Date: Nov. 1, 2007

(54) Blending System and Method

(76) Inventors: Raymond Herbert Scherzer, Durham, NC (US); Dwight Sherod Walker, Durham, NC (US); Charles Rupert Gillham, Brentford (GB); Christopher Michael Gilmour, Brentford (GB); Sander Van Den Ban, Brentford (GB); Andrew Rodericke Taylor, Ware (GB); Stephen Charles Foster, Ware (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 11/575,615

(22) PCT Filed: Sep. 19, 2005
(86) PCT No.: PCT/US05/33498

§ 371 Date: Mar. 20, 2007

Related U.S. Application Data
(60) Provisional application No. 60/611,890, filed on Sep. 21, 2004.

(51) Int. Cl. B01F 15/02; B01F 15/04; B65B 1/04; G05D 11/02; G05D 11/13

(52) U.S. Cl. 141/2; 141/83; 366/132; 366/152.1; 366/152.4

(57) ABSTRACT

A blending system for and a method of providing a continuous supply of a blend, the system comprising: a blending unit operative to blend batches of a blend comprising a plurality of constituent components; a blend feeding unit operative to receive each blended batch from the blending unit and deliver a continuous supply of the blend; and a control unit for controlling operation of the blending unit such as intermittently to blend batches of the blend.

### FIELD OF THE INVENTION

The present invention relates to a blending system for and a method of providing a continuous supply of a blend, in particular a powder blend.

### BACKGROUND OF THE INVENTION

Powder blends are used, for example, as inhalation substances in dry powder inhalers (DPIs). One such inhaler is the DISKUS (RTM) inhaler, which is a metered-dose dry powder inhaler (MDPI) as supplied by GlaxoSmithKline plc (Brentford, Middlesex, UK) and disclosed, for example, in U.S. Pat. No. 5,873,360, the content of which is herein incorporated by reference. An exemplary powder formulation, which is available as SERETIDE/ADVAIR (RTM) formulations, comprises salmeterol xinafoate, as a bronchodilator, fluticasone propionate, as a corticosteroid, and lactose, as an excipient.

Exemplary apparatus for the filling of the DISKUS (RTM) dry powder inhaler are disclosed in EP-A-0474466, WO-A-00/071419 and WO-A-03/086863. Such filling apparatus require the continuous supply of a blended powder formulation in order to allow for the continuous filling of such inhalers.

It is an aim of the present invention to provide an improved blending system for and method of providing a continuous supply of a blend, in particular a powder blend.

### SUMMARY OF THE INVENTION

In one aspect the present invention provides a blending system for providing a continuous supply of a blend, the system comprising: a blending unit operative to blend batches of a blend comprising a plurality of constituent components; a blend feeding unit operative to receive each blended batch from the blending unit and deliver a continuous supply of the blend; and a control unit for controlling operation of the blending unit such as intermittently to blend batches of the blend.

Preferably, the control unit includes an energy sensor for sensing an energy being imparted by the blending unit to the constituent components in blending the same and enabling control of the blending unit.

Preferably, the control unit includes a blend characteristic sensor for sensing at least one parameter of the blend such as to enable control of the blending unit to produce a blend having at least one predeterminable blend characteristic.

Preferably, the control unit includes a low-level sensor for sensing when an amount of the blend contained by the blend feeding unit is below a low-level threshold value and causing operation of the blending unit in response to the same.

Preferably, the system further comprises: a plurality of constituent feeding units for charging the blending unit with the constituent components for each batch.

More preferably, the constituent feeding units each comprise a constituent reservoir which contains a respective constituent component and a constituent feeder which is operative to charge a predeterminable amount of the constituent component into the blending unit.

Preferably, the blending unit comprises a blending vessel in which the constituent components are contained and an agitator for blending the constituent components in the blending vessel.

Preferably, the blend feeding unit comprises a blend reservoir which receives each blended batch as blended by the blending unit and a blend feeder which is operative to deliver a continuous supply of the blend.

In one embodiment the blending unit comprises an infeed unit through which the constituent components are charged into the blending vessel.

Preferably, the infeed unit includes a plurality of infeed ports through which the constituent components are charged by respective ones of the constituent feeding units.

More preferably, at least one of the infeed ports is disposed at a height greater than at least one other of the infeed ports.

In one embodiment the infeed unit comprises an ionising unit which is operative to provide an effective ionising output which eliminates or at least substantially reduces the effect of static.

In one embodiment the constituent components comprise powders.

In one embodiment at least one of the constituent components comprises an active pharmaceutical substance, suitably the blend is an inhalable pharmaceutical powder blend.

The present invention also extends to a filling apparatus, comprising: the above-described system; and a filling apparatus for receiving the continuous supply of the blend from the blend feeding unit and filling elements with the same.

In one embodiment the elements comprise blisters of a blister packaging.

In another aspect the present invention provides a method of providing a continuous supply of a blend, the method comprising the steps of: delivering a continuous supply of a blend comprising a plurality of constituent components from a blend feeding unit; intermittently blending batches of the blend using a blending unit; and delivering each blended batch to the blend feeding unit.

Preferably, the method further comprises the step of: sensing the energy being imparted by the blending unit to the constituent components in blending the same; and wherein the blending step includes the step of: controlling the blending unit in response to the sensed imparted energy.

Preferably, the method further comprises the step of: sensing at least one parameter of the blend; and wherein the blending step includes the step of: controlling the blending unit in response to the sensed at least one parameter to produce a blend having at least one predeterminable blend characteristic.

Preferably, the method further comprises the step of: sensing when an amount of the blend contained by the blend feeding unit is below a low-level threshold value; and performing the blending step in response to sensing that the amount of the blend contained by the blend feeding unit is below the low-level threshold value.

Preferably, the blending step includes the step of: charging predeterminable amounts of the constituent components for each batch into a blending vessel of the blending unit.

In one embodiment the blending unit comprises an infeed unit through which the constituent components are charged into the blending vessel.

Preferably, the infeed unit includes a plurality of infeed ports through which the respective constituent components are charged.

More preferably, at least one of the infeed ports is disposed at a height greater than at least one other of the infeed ports, such that the at least one constituent component charged through the at least one of the infeed ports acts to flush the at least one constituent component charged through the at least one other of the infeed ports.

In one embodiment the method further comprises the step of: providing an effective ionising output at the infeed unit which eliminates or at least substantially reduces the effect of static.

Preferably, the blend feeding unit comprises a blend reservoir which receives each blended batch as blended by the blending unit and a blend feeder which is operative to deliver a continuous supply of the blend.

In one embodiment the constituent components comprise powders.

In one embodiment at least one of the constituent components comprises an active pharmaceutical substance.

The present invention also extends to a method of filling elements using a filling apparatus which is supplied by the above-described method.

In one embodiment the elements comprise blisters of a blister packaging.

In yet another aspect the present invention provides a blending system, comprising: a blending unit operative to blend a plurality of constituent components to provide a blend; and a control unit for controlling operation of the blending unit, wherein the control unit includes a blend characteristic sensor for sensing at least one parameter of the blend such as to enable control of the blending unit to produce a blend having at least one predeterminable blend characteristic.

In one embodiment the control unit includes an energy sensor for sensing an energy being imparted by the blending unit to the constituent components in blending the same and enabling control of the blending unit.

Preferably, the system further comprises: a plurality of constituent feeding units for charging the blending unit with the constituent components for each batch.

More preferably, the constituent feeding units each comprise a constituent reservoir for containing a respective constituent component and a constituent feeder which is operative to charge a predeterminable amount of the constituent component into the blending unit.

Preferably, the blending unit comprises a blending vessel in which the constituent components are containable and an agitator for blending the constituent components in the blending vessel.

In one embodiment the blending unit comprises an infeed unit through which the constituent components are charged into the blending vessel.

Preferably, the infeed unit includes a plurality of infeed ports through which the constituent components are charged by respective ones of the constituent feeding units.

More preferably, at least one of the infeed ports is disposed at a height greater than at least one other of the infeed ports.

In one embodiment the infeed unit comprises an ionising unit which is operative to provide an effective ionising output which eliminates or at least substantially reduces the effect of static.

In one embodiment the constituent components comprise powders.

In one embodiment at least one of the constituent components comprises an active pharmaceutical substance.

In still yet another aspect the present invention provides a method of blending a plurality of constituent components to provide a blend, the method comprising the steps of: charging predeterminable amounts of a plurality of constituent components into a blending vessel of a blending unit; blending the constituent components using the blending unit; sensing at least one parameter of the blend; and controlling the blending unit in response to the sensed at least one parameter to produce a blend having at least one predeterminable blend characteristic.

In one embodiment the method further comprises the step of: sensing the energy being imparted by the blending unit to the constituent components in blending the same; and controlling the blending unit in response to the sensed imparted energy.

In one embodiment the blending unit comprises an infeed unit through which the constituent components are charged into the blending vessel.

Preferably, the infeed unit includes a plurality of infeed ports through which the respective constituent components are charged.

More preferably, at least one of the infeed ports is disposed at a height greater than at least one other of the infeed ports, such that the at least one constituent component charged through the at least one of the infeed ports acts to flush the at least one constituent component charged through the at least one other of the infeed ports.

In one embodiment the method further comprises the step of: providing an effective ionising output at the infeed unit which eliminates or at least substantially reduces the effect of static.

In one embodiment the constituent components comprise powders.

In one embodiment at least one of the constituent components comprises an active pharmaceutical substance.

The present invention also extends to a method of filling elements using a filling apparatus which is supplied by the above-described method.

In one embodiment the elements comprise blisters of a blister packaging.

### BRIEF DESCRIPTION OF THE DRAWINGS

A preferred embodiment of the present invention will now be described hereinbelow by way of example only with reference to the accompanying drawing, in which:

FIG. 1 schematically illustrates a blending system in accordance with a preferred embodiment of the present invention.

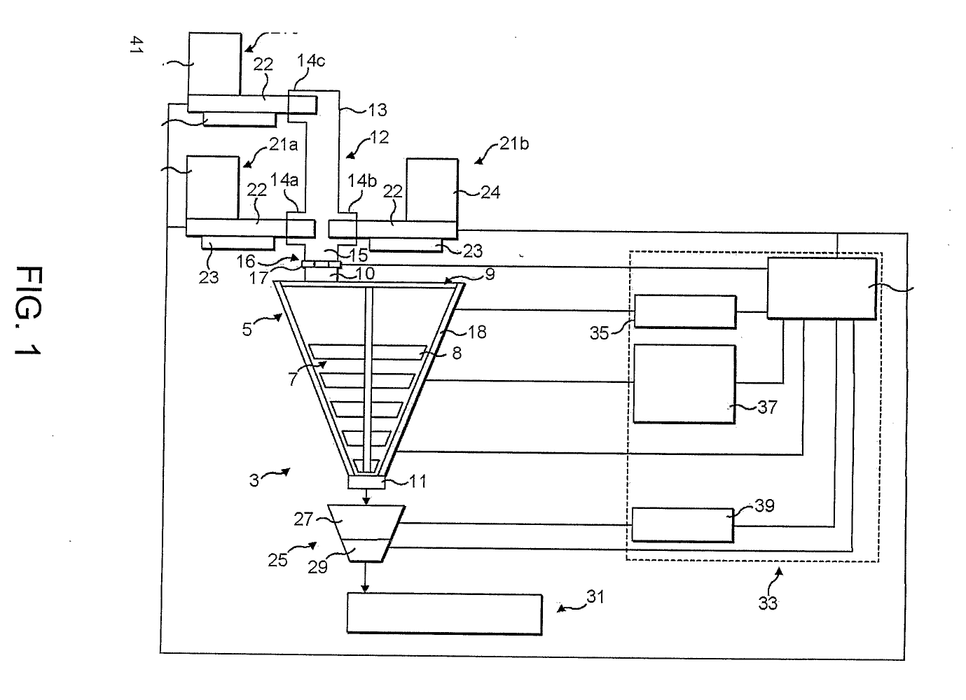

### DETAILED DESCRIPTION OF A PREFERRED EMBODIMENT

The blending system comprises a blending unit 3 for mixing a plurality of constituent components, in this embodiment powders, to provide batches of a blend each having predetermined blend characteristics, typically a predetermined homogeneity and moisture, and, where necessary, a required agglomeration of the constituent components.

In this embodiment the blending unit 3 comprises a conical blender, here a Cyclomix 5 blender having a 5 L working capacity as supplied by Hosokawa Micron Ltd (Runcorn, Cheshire, UK), which comprises a conical blending vessel 5 in which the constituent components are blended, an agitator 7, here centrally mounted in the blending vessel 5, which comprises a plurality of blades 8 and acts mechanically, here as driven by a variable-speed electrical drive motor, to blend the constituent components in the blending vessel 5, a lid 9 which encloses the upper end of the blending vessel 5, a first, inlet valve 10, in this embodiment a butterfly valve which is fluidly connected to the lid 9, through which the constituent components are delivered into the blending vessel 5, and a second, outlet valve 11 which is fluidly connected to the lower, narrow end of the blending vessel 5, such as to allow for the selective emptying of the blending vessel 5. As will be described in more detail hereinbelow, the speed of the agitator 7 is controllable to enable control of the blending of the constituent components.

In this embodiment the blending unit 3 further comprises at least one, in this embodiment a single infeed unit 12 through which the constituent components are fed to the blending vessel 5.

The infeed unit 12 comprises a tubular chute body 13 which is in fluid communication with the blending vessel 5, in this embodiment the broad, upper end of the blending vessel 5, and includes a plurality of infeed ports 14, in this embodiment first, second and third infeed ports 14a, 14b, 14c, through which respective ones of the constituent components are fed, and an outfeed port 15 through which the constituent components are delivered to the blending vessel 5. It will be understood that the tubular chute body 13 can include any number of infeed ports 14 in dependence upon the number of constituent components in any blend.

In this embodiment, where the blend is a pharmaceutical powder blend, active components are fed through the first and second infeed ports 14a, 14b and an inactive excipient is fed through the third infeed port 14c, and the first and second infeed ports 14a, 14b are disposed at a height lower than the third infeed port 14c, such that the inactive excipient, which is delivered in a far greater quantity than the active components, acts to entrain or flush the active components into blending vessel 5.

In this embodiment the infeed unit 12 further comprises an ionising unit 16 which comprises a ring electrode 17, here an EI RE ring electrode as supplied by HAUG GmbH & Co KG (Leinf.-Echterdingen, Germany), which is disposed below the lower end of the outfeed port 15 of the tubular chute body 13, and is operative to provide an effective ionising output which eliminates or at least substantially reduces the effect of static, which could otherwise build up in the tubular chute body 13, in particular at the outfeed port 15 of the tubular chute body 13, and thus provides for the free flow of the constituent components from the tubular chute body 13 into the blending vessel 5.

In this embodiment the outlet valve 11 has a flat upper surface, such as not to present partially-enclosed cavities, which could act to trap parts of the blend. In an alternative embodiment the outlet valve 11 could have a concave upper surface.

In this embodiment the blending vessel 5 includes a heating jacket 18 which allows for the temperature of the blending vessel 5 to be controlled, either by introducing or withdrawing heat.

The blending system further comprises a plurality of constituent feeding units 21, in this embodiment first, second and third constituent feeding units 21a, 21b, 21c, each for receiving a respective constituent component and being operative to charge the blending vessel 5 of the blending unit 3 through respective ones of the infeed ports 14a, 14b, 14c with predetermined amounts of the constituent components. It will be understood that the blending system can include any number of constituent feeding units 21 in dependence upon the number of constituent components in any blend.

The constituent feeding units 21a, 21b, 21c each comprise a constituent feeder 22, in this embodiment a screw feeder, here a K-PH-CL-KT20 feeder as supplied by K-Tron Limited (Cheadle Heath, Stockport, UK), which is operative to charge the blending vessel 5 of the blending unit 3 with a predetermined amount of the respective constituent component in such a manner as not to alter the physical properties of the constituent component. In a preferred embodiment the constituent feeding units 21a, 21b, 21c are charged when the agitator 7 of the blending unit 3 is stationary.

In one embodiment the constituent feeding units 21a, 21b, 21c can be operated simultaneously, such as to charge the constituent components simultaneously into the blending vessel 5 of the blending unit 3.

In another embodiment the constituent feeding units 21a, 21b, 21c can be operated in succession, such as to charge the constituent components successively into the blending vessel 5 of the blending unit 3 to provide a layered or sandwich structure.

In this embodiment, where the blend is a pharmaceutical powder blend, such as for inhalation, the first and second constituent feeding units 21a, 21b feed active components and the third constituent feeding unit 21c feeds an inactive excipient; this allowing for the development of a sandwich structure comprising, for example, inactive excipient/first active component, inactive excipient/second active component/inactive excipient. As discussed hereinabove, by providing for the feeding of inactive excipient subsequent to the feeding of an active component, the inactive excipient acts to flush the active component from the tubular chute body 13 into the blending vessel 5 of the blending unit 3.

In this embodiment the constituent feeding units 21a, 21b, 21c each further comprise a weigh scale 23, here a K-SFS-24 weigh scale as supplied by K-Tron Limited (Cheadle Heath, Stockport, UK), which is utilized to weigh the contained constituent component and provide for control of the respective constituent feeder 22 using a loss-in-weight feedback control loop. In this embodiment the constituent feeders 22 each have a fixed feed time, such that the quantity of the constituent component charged by any of the constituent feeders 22 is controlled by altering the feed rate thereof.

In this embodiment the constituent feeding units 21a, 21b, 21c each include a feed hopper 24 and a docking unit which provides for the docking of transit containers containing the respective constituent component. In a preferred embodiment the docking units are specifically configured only to allow for the docking of transit containers of one kind, that is, containing the respective constituent component, thereby avoiding cross-contamination of the constituent components. In this embodiment the feed hoppers 24 have a volume of 10 L, but, where any constituent component is to be delivered in significantly greater proportion, such as an inactive excipient in an inhalation powder blend, the volume of the feed hopper 24 of the respective constituent feeding unit 21a, 21b, 21c can be greater, for example, having a volume of 20 L.

The blending system further comprises a blend feeding unit 25 which comprises a blend reservoir 27 which acts as a buffer for containing an amount of the blend, and a blend feeder 29 which is operative continuously to feed the blend at a predetermined rate to a downstream station, in this embodiment, and only by way of exemplary embodiment, a filling apparatus 31 for filling the blisters of the blister elements of the above-mentioned DISKUS (RTM) inhaler, and, for example, any one of the filling apparatus disclosed in EP-A-0474466, WO-A-00/071419 and WO-A-03/086863, the contents of which are herein incorporated by reference.

In one embodiment the blend reservoir 27 can include a slow-speed stirrer to prevent constituent segregation in the contained blend.

In this embodiment the blend feeder 29 comprises a screw feeder, here a K-PH-CL-KT20 feeder as supplied by K-Tron Limited (Cheadle Heath, Stockport, UK), which is operative continuously to feed the blend at a predetermined rate and in such a manner as not to alter the physical properties of the blend.

The blending system further comprises a control unit 33 for controlling the operation of the blending unit 3, the constituent component feeding units 21a, 21b, 21c and the blend feeding unit 25.

The control unit 33 comprises an energy sensor 35 for sensing the energy being applied to the constituent components in the blending vessel 5 of the blending unit 3, thereby enabling control of the blending unit 3 to provide a blend having predetermined blend characteristics, typically a predetermined homogeneity, particle size and moisture for a powder blend. Where the blend is an inhalable pharmaceutical powder blend, the blend characteristics can require a predetermined fine particle mass as determined by a cascade impactor.

In this embodiment the energy sensor 35 is a torque sensor for sensing the torque of the agitator 7 of the blending unit 3, and hence the power absorbed by the powder blend in the blending operation. In one embodiment the torque of the agitator 7 is determined by reading the voltage and current of an inverter as connected to the drive motor of the agitator 7 using a power analyser.

The control unit 33 further comprises a blend characteristic sensor 27 for sensing at least one parameter of the blend as being mixed in the blending vessel 5 of the blending unit 3, which sensed parameter is referenced to a reference parameter and enables the characterization of the blend, typically the homogeneity, particle size, temperature and moisture of a powder blend.

In this embodiment the blend characteristic sensor 37 includes a near infra-red (NIR) detector, here an FPTA2000-263 detector as supplied by ABB Bomem Inc (Quebec City, Quebec, Canada), which is utilized to detect the absorbance of the blend in determining the homogeneity and particle size of the blend, which detected absorbance is referenced to an absorbance reference. In this embodiment the near infra-red detector is a two-channel detector which includes probes located at 20% and 80% of the height of the reservoir 5 of the blending unit 3.

In this embodiment the blend characteristic sensor 37 includes a fluorescence detector, here a detector as supplied by Carl Zeiss (Oberkochen, Germany), which is utilized to detect the fluorescence of the blend in determining the homogeneity and particle size of the blend, which detected fluorescence is referenced to an absorbance reference.

In this embodiment the blend characteristic sensor 37 includes an acoustic probe, here a GranuMet XP probe as supplied by Process Analysis and Automation Ltd (Farnborough, Hampshire, UK), which is utilized to detect the acoustic profile of the blend in determining the particle size of the blend, which detected acoustic profile is referenced to an acoustic profile reference.

In this embodiment the blend characteristic sensor 37 includes first and second humidity probes, here HX94C probes as supplied by Omega Engineering, Inc (Stamford, Conn., USA), which are utilized to detect the relative humidities of the headspace of the reservoir 5 of the blending unit 3 and the bulk of the blend in determining the moisture of the blend, which detected humidities are referenced to humidity references. In this embodiment the probes each include a fine metal mesh, here a nickel mesh as supplied by Structure Probe, Inc (SPI Supplies) (West Chester, Pa., USA), over the probe sensing area, in order to protect the probe sensing area from damage.

In this embodiment the blend characteristic sensor 37 includes a plurality of temperature probes, here type K thermocouples, which are disposed in the reservoir 5 of the blending unit 3 and utilized to detect the temperature of the blend, which detected temperature is referenced to a temperature reference.

The control unit 33 further comprises a level sensor 39 for sensing the level of the blend in the blend reservoir 27 of the blend feeding unit 25, thereby enabling the actuation of the blending unit 3 in response to the level of the blend falling below a predetermined low-level threshold. In this embodiment the low-level threshold is set such that the amount of blend remaining in the blend reservoir 27 of the blend feeding unit 25 exceeds that which is required to be delivered thereby during the blending cycle of the blending unit 3, thereby providing for the continuous supply of the blend by the blend feeding unit 25 with only intermittent operation of the blending unit 3.

The control unit 33 further comprises a controller 41, in this embodiment a programmable logic controller, for receiving inputs from the energy sensor 35, the blend characteristic sensor 37 and the level sensor 39 and, in response thereto, controlling the blending unit 3, the constituent feeding units 21a, 21b, 21c, and the blend feeding unit 25.

In operation, the blend feeder 29 of the blend feeding unit 25 is operated continuously to deliver the blend at a predetermined rate, and, through sensing the level of the blend in the blend reservoir 27 of the blend feeding unit 25 by utilizing the level sensor 39, a blending cycle is performed intermittently, through operation of the blending unit 3 and the constituent feeding units 21a, 21b, 21c, to charge the blend reservoir 27 of the blend feeding unit 25 intermittently with batches of the blend and maintain a sufficient amount of blend in the blend reservoir 27 of the blend feeding unit 25.

In a blending cycle, in this embodiment with the agitator 7 of the blending unit 3 stationary, and with the inlet valve 10 open, the constituent feeding units 21a, 21b, 21c are first operated to charge the blending vessel 5 of the blending unit 3 with predetermined amounts of the respective constituent components, and then, following closure of the inlet valve 10, the blending unit 3 is then operated to generate a batch of the required blend of the constituent components, with the agitator 7 of the blending unit 3 being controlled via the energy sensor 35 of the control unit 33 to control the imparted blending energy and the blend characteristics being sensed by the blend characteristic sensor 37 of the control unit 33. When the blend of any batch has the required blending characteristics, the blending cycle is complete, and the agitator 7 of the blending unit 3 is stopped and the blend released by opening the outlet valve 11 of the blending unit 3 and enabling the transfer of the blend, in this embodiment gravitationally, into the blend reservoir 27 of the blend feeding unit 25.

With this configuration, through the provision of the blend feeding unit 25 and the control of the blending cycle in dependence on the level of the blend in the blend reservoir 27 of the blend feeding unit 25, a robust process system is provided which provides for the continuous delivery of a blend and is not contingent on the continuous operation of the blending unit 3, thus allowing for the blending unit 3 to have a certain downtime in order to accommodate cleaning and repair.

### EXAMPLE

The present invention will now be described by way of example with reference to the following non-limiting Example.

In this Example, for the delivery of the above-mentioned SERETIDE/ADVAIR (RTM) formulation, the constituent reservoirs 24 of the constituent feeding units 21a, 21b, 21c contain respectively salmeterol xinafoate, fluticasone propionate and lactose powders.

The blend feeder 29 of the blend feeding unit 25 is set to deliver blend continuously at a rate of 6 kgh⁻¹, which requires the blending unit 3 to be operated on average twice every hour, where the blending unit 3 provides for the blending of a 3 kg batch in each blending cycle.

In a typical blending cycle, the time for the constituent feeding units 21a, 21b, 21c to charge the blending vessel 5 of the blending unit 3 is about 4 minutes, the time for the blending unit 3 to blend the constituent components is about 10 minutes and the time for the gravitational emptying of the batch of the blend from the blending vessel 5 of the blend feeding unit 3 into the blend reservoir 27 of the blend feeding unit 25 is about 1 min, making a total cycle time of about 15 minutes.

Thus, in this Example, on average, the blending unit 3 is required to be operative only for half an hour in every hour of operation of the blend feeding unit 25.

Finally, it will be understood that the present invention has been described in its preferred embodiment and can be modified in many different ways without departing from the scope of the invention as defined by the appended claims.

Although described in relation to the blending of powder blends, the present can have application to the blending of high solids content pastes.

In an alternative embodiment any of the constituent feeding units 21a, 21b, 21c can include instead include a bulk feeder where the respective constituent component is to be delivered in significantly greater proportion.

Also, as regards the provision of reference signs in the appended claims, it is to be understood that reference signs are provided only for illustrative purposes and are not intended to confer any limitation to the claimed invention.

1. A blending system for providing a continuous supply of a blend, the system comprising:
a blending unit (3) operative to blend batches of a blend comprising a plurality of constituent components;
a blend feeding unit (25) operative to receive each blended batch from the blending unit (3) and deliver a continuous supply of the blend; and
a control unit (33) for controlling operation of the blending unit (3) such as intermittently to blend batches of the blend.

2. The system of claim 1, wherein the control unit (33) includes an energy sensor (35) for sensing an energy being imparted by the blending unit (3) to the constituent components in blending the same and enabling control of the blending unit (3).

3. The system of claim 1 or 2, wherein the control unit (33) includes a blend characteristic sensor (37) for sensing at least one parameter of the blend such as to enable control of the blending unit (3) to produce a blend having at least one predeterminable blend characteristic.

4. The system of any of claims 1 to 3, wherein the control unit (33) includes a low-level sensor (39) for sensing when an amount of the blend contained by the blend feeding unit (25) is below a low-level threshold value and causing operation of the blending unit (3) in response to the same.

5. The system of any of claims 1 to 4, further comprising:
a plurality of constituent feeding units (21a, 21b, 21c) for charging the blending unit (3) with the constituent components for each batch.

6. The system of claim 5, wherein the constituent feeding units (21a, 21b, 21c) each comprise a constituent reservoir (24) for containing a respective constituent component and a constituent feeder (22) which is operative to charge a predeterminable amount of the constituent component into the blending unit (3).

7. The system of any of claims 1 to 6, wherein the blending unit (3) comprises a blending vessel (5) in which the constituent components are containable and an agitator (7) for blending the constituent components in the blending vessel (5).

8. The system of claim 7, wherein the blending unit (3) comprises an infeed unit (12) through which the constituent components are charged into the blending vessel (5).

9. The system of claim 8, wherein the infeed unit (12) includes a plurality of infeed ports (14a, 14b, 14c) through which the constituent components are charged by respective ones of the constituent feeding units (21a, 21b, 21c).

10. The system of claim 9, wherein at least one of the infeed ports (14a, 14b, 14c) is disposed at a height greater than at least one other of the infeed ports (14a, 14b, 14c).

11. The system of any of claims 8 to 10, wherein the infeed unit (12) comprises an ionising unit (16) which is operative to provide an effective ionising output which eliminates or at least substantially reduces the effect of static.

12. The system of any of claims 1 to 11, wherein the blend feeding unit (25) comprises a blend reservoir (27) to receive each blended batch as blended by the blending unit (3) and a blend feeder (29) which is operative to deliver a continuous supply of the blend.

13. The system of any of claims 1 to 12, wherein the constituent components comprise powders.

14. The system of any of claims 1 to 13, wherein at least one of the constituent components comprises an active pharmaceutical substance.

15. A filling apparatus, comprising:
the system of any of claims 1 to 14; and
a filling apparatus (31) for receiving the continuous supply of the blend from the blend feeding unit (25) and filling elements with the same.

16. The apparatus of claim 15, wherein the elements comprise blisters of a blister packaging.

17. A method of providing a continuous supply of a blend, the method comprising the steps of:
delivering a continuous supply of a blend comprising a plurality of constituent components from a blend feeding unit (25);
intermittently blending batches of the blend using a blending unit (3); and
delivering each blended batch to the blend feeding unit (25).

18. The method of claim 17, further comprising the step of:
sensing the energy being imparted by the blending unit (3) to the constituent components in blending the same; and
wherein the blending step includes the step of:
controlling the blending unit (3) in response to the sensed imparted energy.

19. The method of claim 17 or 18, further comprising the step of:
sensing at least one parameter of the blend; and
wherein the blending step includes the step of:
controlling the blending unit (3) in response to the sensed at least one parameter to produce a blend having at least one predeterminable blend characteristic.

20. The method of any of claims 17 to 19, further comprising the step of:
sensing when an amount of the blend contained by the blend feeding unit (25) is below a low-level threshold value; and
performing the blending step in response to sensing that the amount of the blend contained by the blend feeding unit (25) is below the low-level threshold value.

21. The method of any of claims 17 to 20, wherein the blending step includes the step of:
charging predeterminable amounts of the constituent components for each batch into a blending vessel (5) of the blending unit (3).

22. The method of claim 21, wherein the blending unit (3) comprises an infeed unit (12) through which the constituent components are charged into the blending vessel (5).

23. The method of claim 22, wherein the infeed unit (12) includes a plurality of infeed ports (14a, 14b, 14c) through which the respective constituent components are charged.

24. The method of claim 23, wherein at least one of the infeed ports (14a, 14b, 14c) is disposed at a height greater than at least one other of the infeed ports (14a, 14b, 14c), such that the at least one constituent component charged through the at least one of the infeed ports (14a, 14b, 14c) acts to flush the at least one constituent component charged through the at least one other of the infeed ports (14a, 14b, 14c).

25. The method of any of claims 22 to 24, further comprising the step of:
providing an effective ionising output at the infeed unit (12) which eliminates or at least substantially reduces the effect of static.

26. The method of any of claims 17 to 25, wherein the blend feeding unit (25) comprises a blend reservoir (27) which receives each blended batch as blended by the blending unit (3) and a blend feeder (29) which is operative to deliver a continuous supply of the blend.

27. The method of any of claims 17 to 26, wherein the constituent components comprise powders.

28. The method of any of claims 17 to 27, wherein at least one of the constituent components comprises an active pharmaceutical substance.

29. A method of filling elements using a filling apparatus (31) which is supplied by the method of any of claims 17 to 28.

30. The method of claim 29, wherein the elements comprise blisters of a blister packaging.

31. A blending system, comprising:
a blending unit (3) operative to blend a plurality of constituent components to provide a blend; and
a control unit (33) for controlling operation of the blending unit (3), wherein the control unit (33) includes a blend characteristic sensor (37) for sensing at least one parameter of the blend such as to enable control of the blending unit (3) to produce a blend having at least one predeterminable blend characteristic.

32. The system of claim 31, wherein the control unit (33) includes an energy sensor (35) for sensing an energy being imparted by the blending unit (3) to the constituent components in blending the same and enabling control of the blending unit (3).

33. The system of claim 31 or 32, further comprising:
a plurality of constituent feeding units (21a, 21b, 21c) for charging the blending unit (3) with the constituent components for each batch.

34. The system of claim 33, wherein the constituent feeding units (21a, 21b, 21c) each comprise a constituent reservoir (24) for containing a respective constituent component and a constituent feeder (22) which is operative to charge a predeterminable amount of the constituent component into the blending unit (3).

35. The system of any of claims 31 to 34, wherein the blending unit (3) comprises a blending vessel (5) in which the constituent components are containable and an agitator (7) for blending the constituent components in the blending vessel (5).

36. The system of claim 35, wherein the blending unit (3) comprises an infeed unit (12) through which the constituent components are charged into the blending vessel (5).

37. The system of claim 36, wherein the infeed unit (12) includes a plurality of infeed ports (14a, 14b, 14c) through which the constituent components are charged by respective ones of the constituent feeding units (21a, 21b, 21c).

38. The system of claim 37, wherein at least one of the infeed ports (14a, 14b, 14c) is disposed at a height greater than at least one other of the infeed ports (14a, 14b, 14c).

39. The system of any of claims 36 to 38, wherein the infeed unit (12) comprises an ionising unit (16) which is operative to provide an effective ionising output which eliminates or at least substantially reduces the effect of static.

40. The system of any of claims 31 to 39, wherein the constituent components comprise powders.

41. The system of any of claims 31 to 40, wherein at least one of the constituent components comprises an active pharmaceutical substance.

42. A method of blending a plurality of constituent components to provide a blend, the method comprising the steps of:
charging predeterminable amounts of a plurality of constituent components into a blending vessel (5) of a blending unit (3);
blending the constituent components using the blending unit (3);
sensing at least one parameter of the blend; and
controlling the blending unit (3) in response to the sensed at least one parameter to produce a blend having at least one predeterminable blend characteristic.

43. The method of claim 42, further comprising the step of:
sensing the energy being imparted by the blending unit (3) to the constituent components in blending the same; and
controlling the blending unit (3) in response to the sensed imparted energy.

44. The method of claim 42 or 43, wherein the blending unit (3) comprises an infeed unit (12) through which the constituent components are charged into the blending vessel (5).

45. The method of claim 44, wherein the infeed unit (12) includes a plurality of infeed ports (14a, 14b, 14c) through which the respective constituent components are charged.

46. The method of claim 45, wherein at least one of the infeed ports (14a, 14b, 14c) is disposed at a height greater than at least one other of the infeed ports (14a, 14b, 14c), such that the at least one constituent component charged through the at least one of the infeed ports (14a, 14b, 14c) acts to flush the at least one constituent component charged through the at least one other of the infeed ports (14a, 14b, 14c).

47. The method of any of claims 42 to 46, further comprising the step of:
providing an effective ionising output at the infeed unit (12) which eliminates or at least substantially reduces the effect of static.

48. The method of any of claims 42 to 47, wherein the constituent components comprise powders.

49. The method of any of claims 42 to 48, wherein at least one of the constituent components comprises an active pharmaceutical substance.

50. A method of filling elements using a filling apparatus (31) which is supplied by the method of any of claims 42 to 49.

51. The method of claim 50, wherein the elements comprise blisters of a blister packaging.

52. A blending system substantially as hereinbefore described with reference to the accompanying drawing.

53. A blending method substantially as hereinbefore described with reference to the accompanying drawing.
